(19) United States
(12) Patent Application Publication
(10) Pub. No.: US 2026/0200579 A1
(43) Pub. Date: Jul. 16, 2026

(54) SYSTEM FOR DISPERSING BIOLOGICAL AGENTS

(71) Applicant: Chandler Bennett, Salinas, CA (US)

(72) Inventor: Chandler Bennett, Salinas, CA (US)

(21) Appl. No.: 19/563,403

(22) Filed: Mar. 11, 2026

Related U.S. Application Data
(63) Continuation of application No. 18/617,989, filed on Mar. 27, 2024, now Pat. No. 12,649,577.
Application No. 18/617,989 is a continuation of application No. 18/476,721, filed on Sep. 28, 2023.
Application No. 18/476,721 is a continuation-in-part of application No. 17/351,092, filed on Jun. 17, 2021, now Pat. No. 12,091,174.
Application No. 17/351,092 is a division of application No. 16/074,756, filed on Dec. 21, 2016, now Pat. No. 11,066,167.
(60) Provisional application No. 62/290,345, filed on Feb. 2, 2016.

(51) Int. Cl. B64D 1/18; A01C 17/00; A01M 9/00; B64C 39/02; B64U 10/10; B64U 10/25; B64U 30/10; B64U 30/20; B64U 101/00

(52) U.S. Cl. CPC B64D 1/18; A01C 17/001; A01C 17/003; A01M 9/0061; B64C 39/024; B64U 10/10; B64U 10/25; B64U 30/10; B64U 30/20; B64U 2101/00; B64U 2201/10

(57) ABSTRACT

A system and method for dispersing biological agents over a target area is disclosed. Biological agents are contained in a dispersal device having a rotatable drum-like container. The dispersal device is mounted on a vehicle, which traverses the target area. A motor rotates the container, causing the biological agents to be released from the dispersal device through a series of openings in the container. In an improved embodiment, the dispersal rate is controlled by an adjustable sleeve wrapped around the container.

### PRIORITY CLAIM

This non-provisional application is a continuation, claiming priority to co-pending U.S. Utility Application Serial Number 18/617,989, entitled "Method and Apparatus used for Biological Control of Agricultural Pests," filed Mar. 27, 2024. Additionally, it is entitled to the benefit of, and claims priority to U.S. Utility Application Serial Number 18/476,721, entitled "Method and Apparatus used for Biological Control of Agricultural Pests," filed Sep. 28, 2023, U.S. Utility Application Serial Number 17/351,092, entitled "Method and Apparatus used for Biological Control of Agricultural Pests," filed Jun. 17, 2021, U.S. Utility Patent Application Serial Number 16/074,756, entitled "Method and Apparatus used for Biological Control of Agricultural Pests," filed Aug. 1, 2018, international application PCT/US2016/068101 entitled "Method and Apparatus for Biological Control of Agricultural Pests," filed on Dec. 21, 2016, and Provisional Patent Application Serial Number 62/290,345, entitled "Method and Apparatus for Biological Control of Agricultural Pests," filed on Feb. 02, 2016; all of which are included by reference as fully set forth herein.

### TECHNICAL FIELD

The present invention relates generally to the field of biological control of agricultural pests, and more specifically without limitation, to a system of dispersing pest control agents over a target area.

### BACKGROUND OF THE INVENTION

Plant pests are a significant factor in the loss of the world's important agricultural crops. Billions of dollars are lost every year in the U.S. and around the world due to infestations of plants by non-mammalian pests including insects. In addition to losses in field crops, insect pests and/or mites are also a burden to vegetable and fruit growers, to producers of ornamental flowers, and to home gardeners. For example, spider mites often attack strawberry fields causing extensive damage to the crop, resulting in significant economic loss to the growers.

Insect pests and/or mites are mainly controlled by intensive applications of chemical pesticides and/or insecticides, which are active through inhibition of insect growth, prevention of insect feeding or reproduction, or cause death. Although the use of such chemicals can result in good control of insect pests, the widespread use of chemical pesticides can result in the appearance of resistant insect varieties. Moreover, high levels of chemicals on horticultural crops are undesirable to many consumers. Further, chemical pesticides can also encourage the spread of the insect pests such as spider mites by killing the beneficial insects that prey on them. Similarly, insect pests or mites are also known to develop quick resistance to various pesticides.

An alternative to using chemical pesticides and/or insecticides is through the application of beneficial insects or mites. The beneficial insects or mites used are advantageously predatory towards pest insects such as two-spotted spider mites and can be applied to crops to control insect pests. Beneficial insects or mites can be dispersed on crop plants in a variety of ways, for example manually or through a controlled release device.

The use of beneficial insects or mite forms part of integrated crop management and integrated pest management programs, combining cultural, biological and chemical means to achieve sustainable pest control. However, a typical problem currently encountered with the release of beneficial insects, predatory mites or other essentially beneficial biological organisms in agricultural fields is that it can be very labor intensive and inaccurate. For instance, hand application is not precise in placement of hots spots and application amounts can vary significantly over a given area.

The application of biologicals by hand is not only labor intensive but poses other problems which result in a higher cost of application of the biologicals. For example, the high cost comes from not only time and related hourly wages but also from insurance, workman's compensation, and other costs associated with manual labor. In addition, hand application of biologicals requires workers to walk through the growing fields which can introduce the problem of stepping on the crops causing damage thereof. Further, using tractors or the like for application of biologicals over and/or on crops may not be practical or even an option in rainy or muddy conditions which delays important treatment of agricultural pests.

In light of the shortcomings in the prior art, there clearly exists a need for the application of materials and/or biological organisms such as beneficial insects or predatory mites using aerial vehicles, specifically unmanned aerial vehicles, for the rapid dispersal of the biological organisms/materials over large or concentrated areas with minimal manual labor.

### SUMMARY OF THE INVENTION

The present invention provides a system and method for dispersing organisms or materials intended to have a beneficial biological effect (referred to herein as “biological agents”), such as predatory mites, over a selected target area, such as a strawberry field, in order to achieve a desired effect on the target area, such as controlling or eradicating spider mites.

In certain embodiments of the present invention, the system features a dispersion unit for dispersing biological agents over a target area. The dispersion unit comprises a rotatable container, such as a cylindrical drum, for containing the biological agents. A motor rotates the container, causing the release of biological agents through a series of openings arranged circumferentially around the container’s wall.

This dispersion unit may be improved by a sleeve wrapped around the container. The sleeve includes a second series of openings, which may be aligned, unaligned, and/or partially aligned with the openings of the container. The sleeve openings and container openings form gaps when aligned or partially aligned, through which the biological agents can pass during operation of the apparatus. This feature thus allows modification of the size, shape, and/or quantity of openings through which the biological agents pass, facilitating control of the dispersion rate.

The dispersion unit may be mounted on a vehicle, such as an unmanned aerial vehicle (UAV), and loaded with a biological control agent, such as predatory mites.

The system disclosed herein may be used to disperse biological agents by enclosing the biological agents within the dispersion unit container, mounting the dispersion unit on a vehicle, traversing over a target area with the vehicle, and rotating the dispersion unit container via an on-board motor, wherein the rotation causes openings in the container wall and/or gaps sleeve to serially rotate around the cavity where the biological agents are contained, facilitating the release of biological agents through the openings;

In various embodiments, the present system may be computer-controlled in combination with a global positioning system (GPS) on the UAV, allowing automatic adjustment of the dispersion rate according to the vehicle position.

### BRIEF DESCRIPTION OF THE DRAWINGS

FIG. 1 is a front perspective view of a dispersal device according to the present invention mounted on an unmanned aerial vehicle (UAV).

FIG. 2 is a front view of a sleeved dispersal device mounted on an unmanned aerial vehicle (UAV).

FIG. 3 is a perspective view of the sleeved dispersal device of FIG. 2.

FIG. 4 is a front view of a dispersal device container and sleeve.

FIG. 5 is a partial top view of the dispersal device container and sleeve, wherein the container openings and sleeve openings are substantially aligned.

FIG. 6 is an additional partial top view of the dispersal device container and sleeve, wherein the container openings and sleeve openings are substantially unaligned.

FIG. 7 is a perspective view of a dispersal device sleeve.

FIG. 8 is a partial front view of a dispersal device sleeve.

### DETAILED DESCRIPTION OF THE INVENTION

The following detailed description is of the best currently contemplated modes of carrying out various embodiments of the invention. The description is not to be taken in a limiting sense, but is made for at least the purpose of illustrating the general principles of the invention, since the scope of the invention is best defined by the appended claims.

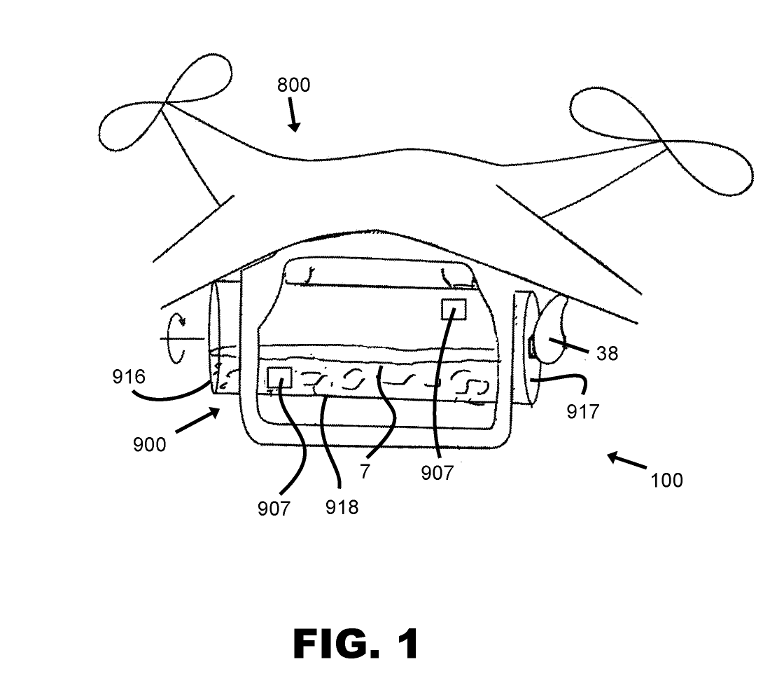

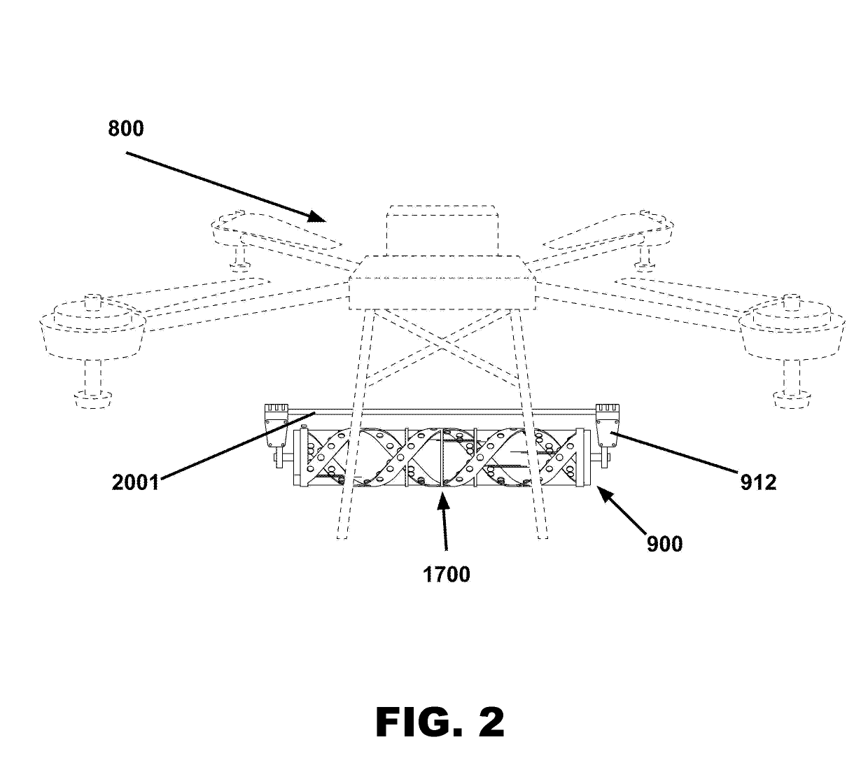

An apparatus 100 used for dispersing biological agents can be securely attached to an unmanned aerial vehicle (UAV) 800 as illustrated in FIGS. 1 and 2. In use, the apparatus 100 can advantageously spread biological agents 7 over a selected target area such as agricultural crops in order to reduce damage caused by the agricultural pests. An example of agricultural pests or organisms known to cause damage to agricultural crops, but not limited to, is mites such as spider mites and insects.

Referring to FIGS. 1-3, in various embodiments, the apparatus 100 includes a rotatable drum 900. Drum 900 may comprise a hollow cylindrical container with an inner cavity 905 and defined by a circular base and an adjacent side wall. In this cylindrical configuration, the drum has a central axis 915, and the inner cavity of the drum is substantially enclosed by a first end wall 916 at one end, a second end wall 917 at the other end (each end wall also referred to herein as a “base”), and a cylindrical wall 918 (also referred to herein as a “side wall”) extending circumferentially around and parallel to the central axis 915 from the first end wall 916 to the second end wall 917. The side wall 918 will optimally comprise a series of openings 907 sized such that biological agents 7 may freely pass through. Drum 900 may be mounted to an aerial vehicle, such as a UAV, or a manned or unmanned ground vehicle, such as a tractor or rover.

In certain embodiments, cylindrical drum 900 is arranged horizontally, such that the central axis 915 of the drum 900 is substantially parallel to the ground, as seen in FIGS. 1-2. In this embodiment, gravity will urge biological agents 7 to a bottom area of the side wall 918 of the inner cavity 905. During operation, motor 38 will rotate 920 drum 900 about its central axis 915. As drum 900 rotates, biological agents 7 contained in the inner cavity 905 will continue to roll towards the bottom area of the side wall 918, exposing biological agents 7 to openings 907 as openings 907 pass by the underside of the drum 900 during rotation. As biological agents 7 pass over openings, biological agents 7 will be released from drum 900 onto the desired surfaces. On occasions, the biological agents 7 in the drum will arrange themselves due to biological preferences. For example, some organisms will migrate to the top of the group of the essentially biological agents 7 in order to get access to air or light, or in some instances naturally gravitate upwards. Accordingly, the rotation of drum 900 serves to mix the biological agents 7 so that different materials are all evenly distributed for dispersion.

These embodiments have the advantage of dispersing biological agents 7 through movement of the drum 900, rather than, for example, through an auger disposed in the drum or other container. Granular materials have a tendency to result in an equilibrium state where the grains are more resistant to movement, such as a “bridged” state. Accordingly, it is beneficial to apply a force to the granular materials to break them apart. Referring again to FIG. 1, for example, as drum 900 rotates, gravity acting on the biological agents 7 causes the biological agents 7 to experience a tumble-like motion. This motion acts to separate grains from each other and eliminate or minimize any bridged or jammed grains.

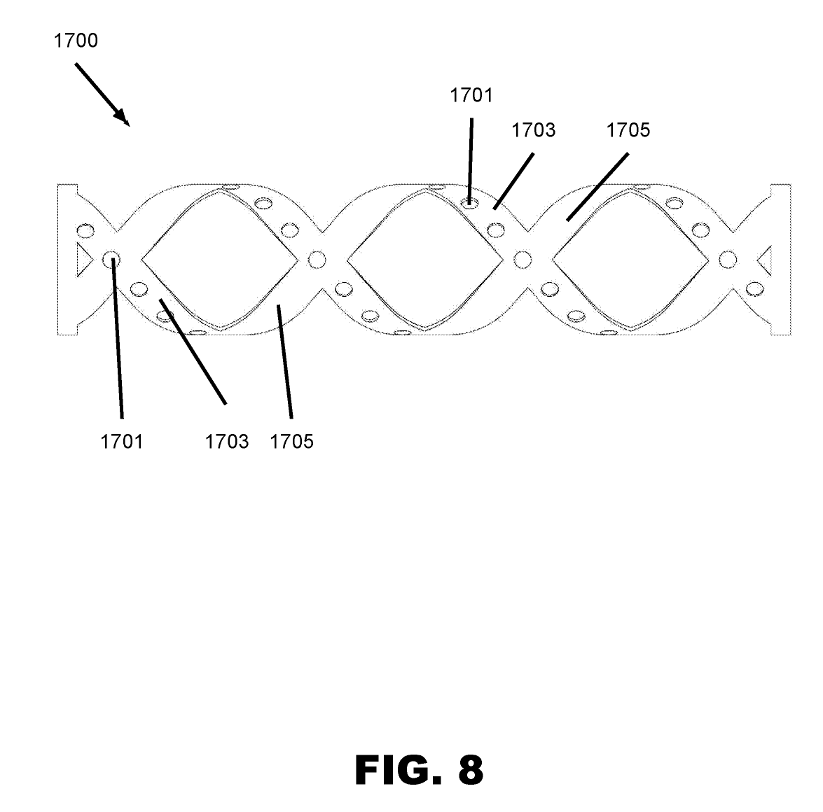

In embodiments illustrated in FIGS. 2-8, the dispersion unit may comprise additional features for adjusting the size, shape, and/or number of openings. These features give operators the ability to control the rate of dispersion of the biological agents 7. Such control is desirable, since the optimal rate of dispersion is variable and depends, among other factors, on the type of crop, the size of the field, the type of organisms or materials to be dispersed, the speed and altitude of the vehicle, and environmental factors.

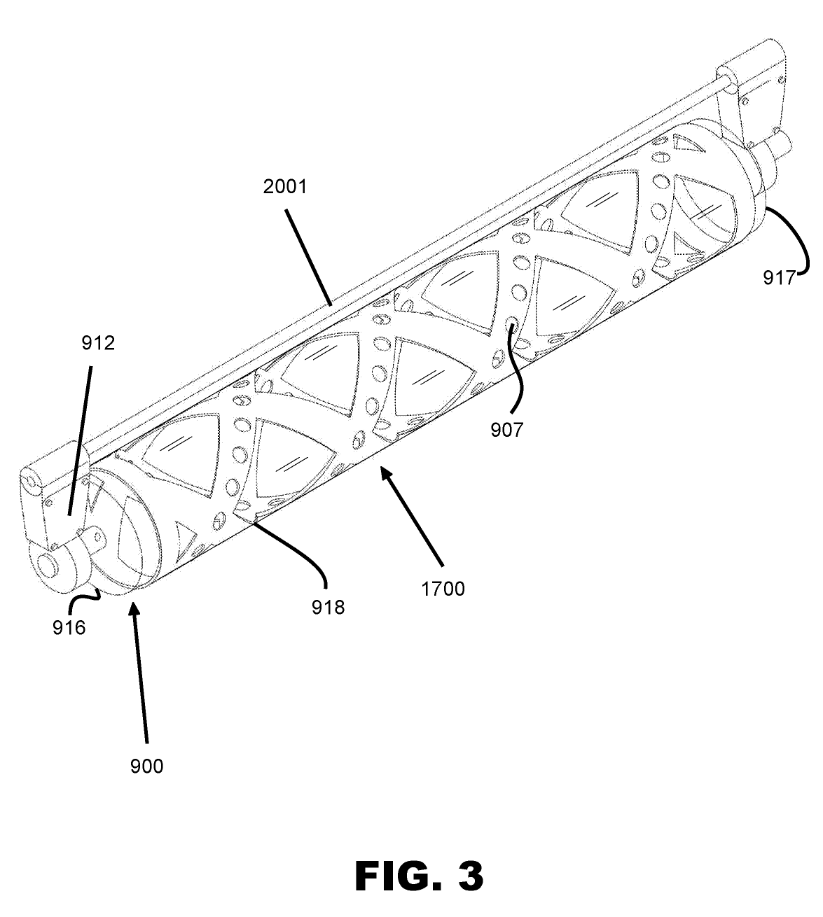

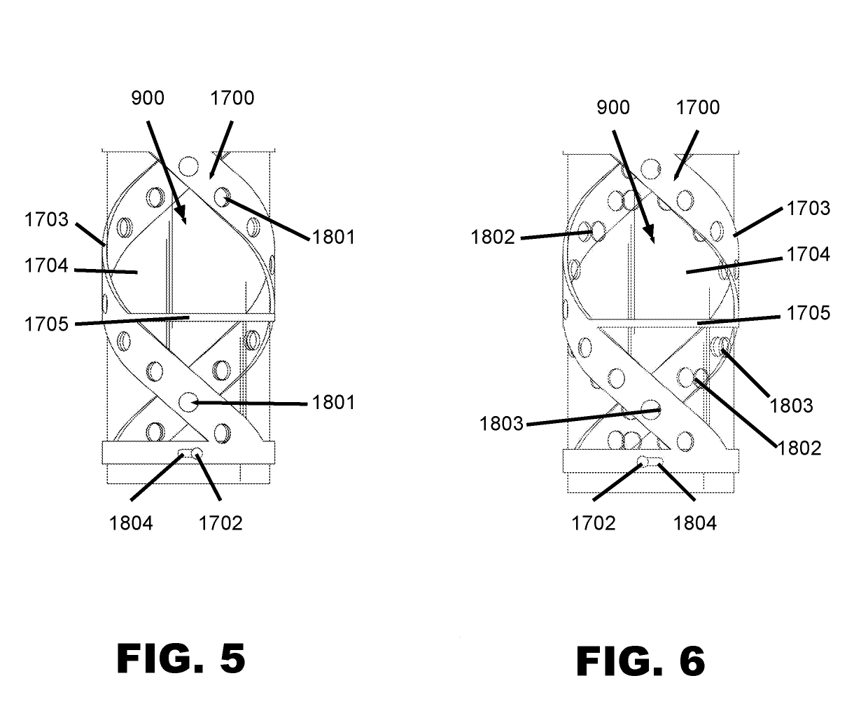

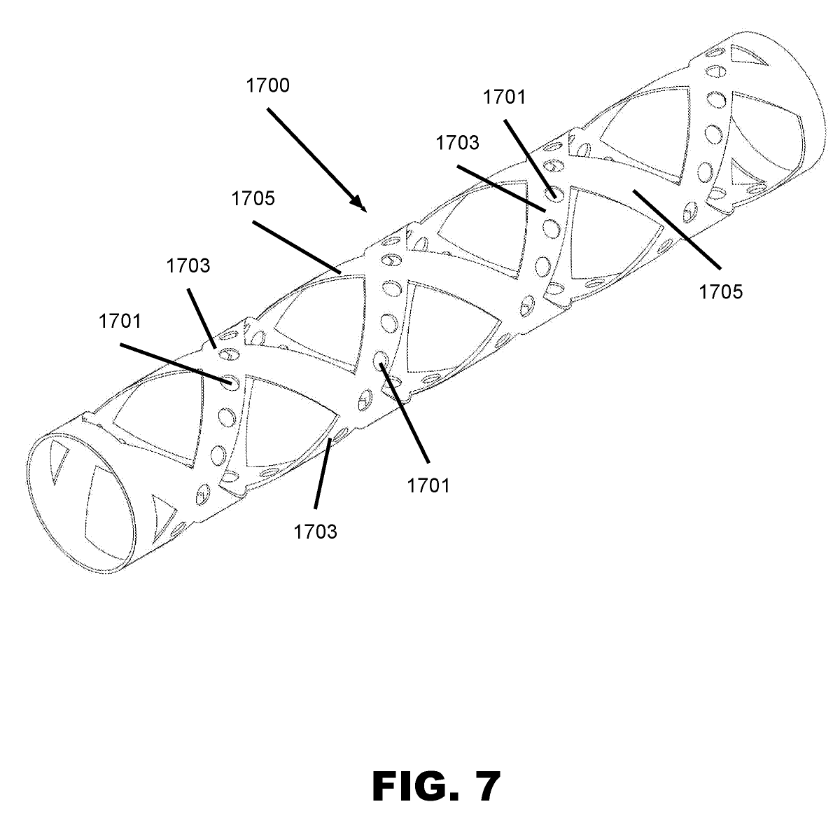

In various embodiments, dispersion control is achieved by means of a sleeve 1700 comprising a surface with a plurality of openings 1701 (see FIG. 7). As best shown in FIG. 3, the sleeve 1700 is arranged proximate to the surface of the drum 900 and its plurality of openings 907. For example, in various embodiments, the sleeve has a substantially cylindrical shape, configured to wrap around the cylindrical drum 900. The sleeve may thus be positioned such that its second plurality of openings 1701 overlap with the drum’s first plurality of openings 907, forming gaps 1801, 1803 through which biological agents 7 can pass (see FIG. 5 and 6). The sleeve 1700 may be positioned such that the sleeve openings 1701 are aligned 1801, unaligned 1802, or partially aligned 1803 with the drum openings 907. Adjusting this alignment modifies the size, shape, and/or number of gaps through which biological agents 7 can pass.

The sleeve 1700 may be coupled to the dispersion unit drum 900 by means of a friction fit or may instead be coupled by means of a fixture element such as a screw 1702. In embodiments featuring a fixture element, a screw slide 1804 or similar element may be utilized to facilitate adjustment of the sleeve openings 1701 relative to the drum openings 907 (see FIG. 5 and 6). For example, in such embodiments, the sleeve 1700 may be rotated around the drum 900, within the path defined by the slide element 1804, when the fixture element 1702 is loosened, and the sleeve’s position relative to the drum is fixed when the fixture element 1702 is tightened.

Particularly with respect to embodiments in which the dispersion unit is designed to be coupled to a UAV 800, it is desirable minimize the weight of the dispersion unit, including the dispersion control components. Reducing weight allows compatibility with a greater variety of vehicles and improves efficiency and maneuverability during flight. It is therefore desirable for the surface of the dispersion control sleeve to comprise the minimal surface area required to achieve the desired alignment 1801, non-alignment 1802, and/or partial alignment 1803 between the sleeve openings 1701 and drum openings 907. For example, the sleeve surface may comprise a spiral or helix shape 1703, configured to wrap around the dispersion drum, such that substantially the remainder of the drum surface 1704 is exposed.

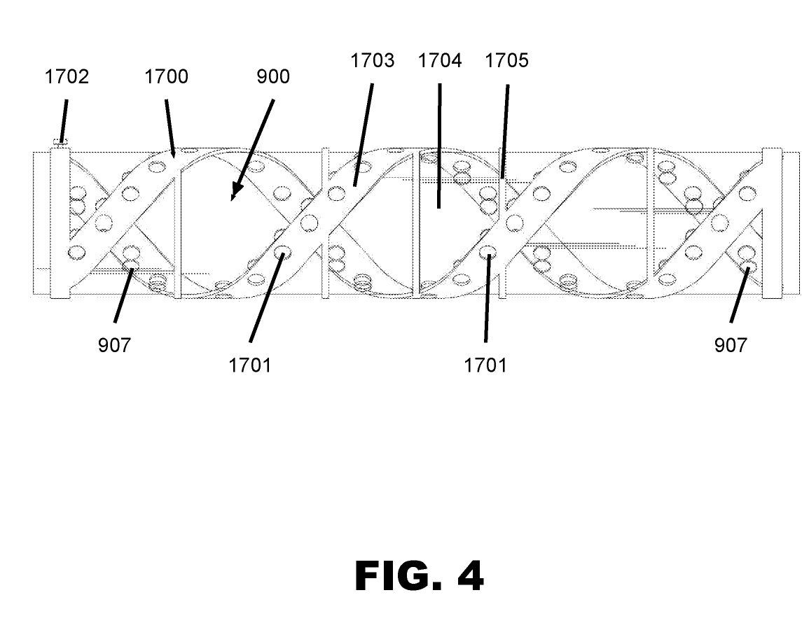

Reduction of weight and surface area, however, must be balanced against other desirable structural characteristics; in particular, the sleeve 1700 must be sufficiently strong and durable to withstand repeated flight and must be sufficiently rigid to resist malformation when rotated and/or when repositioned relative to the drum 900. To achieve greater strength, durability, and rigidity, the sleeve surface may be reinforced with support structure 1705. For example, as illustrated in FIGS. 4-6, the support structure 1705 may comprise additional sleeve surface area forming narrow strips intersecting the sleeve’s primary helical structure 1703 at oblique angles and arranged such that, when the sleeve is positioned around the drum, the length of the support structure 1705 is substantially perpendicular to the drum’s cylindrical surface and substantially parallel to the drum’s bases 916, 917. FIGS. 3, 7, and 8 illustrate an alternative embodiment of the support structure 1705, one which further increases sleeve rigidity. In this embodiment the support structure 1705 instead comprises a second helix shape, substantially inverse relative to the primary helical structure 1703 and intersecting the primary helical structure 1703.

The dispersion unit can be configured such that the drum 900 and sleeve 1700 rotate in unison, in which case the gaps 1801, 1803 formed by alignment of the sleeve openings 1701 and drum openings 907 remain constant during operation, unless the positioning of the sleeve is adjusted. Alternatively, the dispersion unit can be configured such that the sleeve 1700 remains in a fixed position while the drum 900 rotates, in which case alignment of the sleeve openings 1701 and drum openings 907 is dynamic during operation.

In various embodiments, dispersion drum 900 and sleeve 1700 may be coupled to an UAV 800 via a mounting strut 2001 (FIG. 2 and 3). Strut 2001, drum 900, and sleeve 1700 may further be coupled to motor holding area 912, which houses the dispersion unit motor 38 that rotates drum 900.

In further embodiments, positioning of the dispersion control sleeve 1700 may be adjusted mechanically. For example, the dispersion unit may further comprise kinetic mechanisms configured to unlock, rotate, and re-lock the sleeve 1700 in response to electrical signals or other input. These mechanisms can be controlled remotely by a UAV operator, allowing dispersion rate to be modified mid-flight. Similarly, where the dispersion unit is coupled to a ground vehicle, the sleeve may be adjusted by a driver or remote operator. In alternative embodiments, sleeve positioning may be computer-controlled, such that adjustments are made automatically in response to data collected by sensors and/or other conditions, which conditions may be predetermined by the operator and/or determined dynamically by computer algorithms.

In operation, the dispersion unit 100 is securely mounted to a vehicle, such as an unmanned aerial vehicle (UAV) 800 as illustrated in FIGS. 1 and 2. Biological agents 7 are secured within the container 900. The vehicle then traverses a target area, such as an agricultural crop while the dispersion unit releases and disperses the biological agents 7. Optionally, the path of the vehicle 800 can be advantageously controlled by a global positioning system (GPS) in order to uniformly apply the biological agents over the target area.

It is envisioned that in order to minimize a worker's need to interact with the biological agents 7, drum 900 may be unitized and sold as cartridges pre• filled with the biological agents 7. This allows for a standardized mixture of the biological agents 7 to be used without individual workers needing to measure and mix organisms prior to each use. In such an embodiment, drum 900, would be filled with a mixture of the biological agents 7, and the cap secured. A thin removable covering may then be applied to the exterior of the drum 900 to cover the dispersing ports or, in embodiments where dispersion unit includes a sleeve 1700, sleeve openings 1701 may be adjusted to a closed (non-aligned) position 1803. Accordingly, the biological agents 7 will be secure in the drum 900 during transport or non-use. Once the device is to be used, the removable covering can be removed, exposing the dispersing ports so the biological agents 7 may be released to the target area.

In one embodiment of the invention, the system includes biological agents 7 in the form of predatory mites used to control and/or to eradicate pests such as insects, nematodes or arachnids. Typically, the predator mites will be useful for control of the common crop pests such as thrips, spider mites and whitefly. Most predatory mites belong to the family Phytoseiidae (order Acarina). The most common predators used for biological control are Amblyseius swirskii, Phytoseiulus persimilis, Amblyseius califomicus, Amblyseius cucumeris, Amblyseius degenerans, Hypoaspis miles, Aphidoletes aphidimyza, Aphelinus abdominalis, Aphidius colemani, Chrysoperla carnea, Aphidius ervi, and Diglyphus isaea, all of which may be used in conjunction with the present invention.

Phytoseiulus persimilis is advantageously used in biological control programs for two spotted spider mites (Tetranychus urticae), and related Tetranychus species. The mites are predators as nymphs and adults, mostly feeding on spider mite eggs and nymphs, but also consuming adults.

In alternative embodiments of the invention, the device 100 can be used to apply and/or spread various types of other materials. These materials include, but are not limited to, the application of seeds, dry chemicals such as herbicides, pesticides, fungicides, dry fertilizers, and the application of agricultural amendments.

It should be understood that the foregoing relates to various embodiments of the invention and that modifications may be made without departing from the spirit and scope of the invention. It should also be understood that the present invention is not limited to the designs mentioned in this application and the equivalent designs in this description, but it is also intended to cover other equivalents now known to those skilled in the art, or those equivalents which may become known to those skilled in the art in the future.

What is claimed is:

1. A method for dispersing biological agents, the method comprising:
containing a plurality of biological organisms in a cylindrical container having an inner cavity, a central axis, a container wall extending circumferentially around the central axis, and a plurality of container openings extending through the container wall and arranged circumferentially around the central axis;
mounting the cylindrical container on an unmanned vehicle;
traversing over a target area with the unmanned vehicle;
rotating the cylindrical container around the central axis by means of a motor, wherein the rotation causes the gravity-assisted release of the plurality of biological agents through the plurality of container openings;
dispersing the biological organisms over the target area by means of at least the rotation of the drum and the traversal of the unmanned vehicle.

2. The method of claim 1, wherein the central axis of the cylindrical container is oriented horizontally.

3. The method of claim 1, further comprising the step of mixing the biological organisms by rotating the cylindrical container.

4. The method of claim 1, further comprising the step of modifying the rate of dispersing the biological agents by modifying the cylindrical container’s rotation speed.

5. The method of claim 4, further comprising the step of using a global positioning system (GPS) to at least partly determine the cylindrical container’s rotation speed.

6. The method of claim 1, wherein the biological agents are predatory mites.

7. The method of claim 6, wherein the predatory mites are selected from a group consisting of: Amblyseius swirskii, Phytoseiulus persimilis, Amblyseius califomicus, Amblyseius cucumeris, Amblyseius degenerans, Hypoaspis miles, Aphidoletes aphidimyza, Aphelinus abdominalis, Aphidius colemani, Chrysoperla camea, Aphidius ervi, and Diglyphus isaea.

8. The method of claim 1, wherein the unmanned vehicle is an aerial drone.

9. The method of claim 1, wherein the cylindrical container has a sleeve wrapped at least partially around the container wall and the sleeve has a plurality of sleeve openings.

10. The method of claim 9, further comprising the steps of:
aligning the container openings and the sleeve openings to form gaps; and
releasing the biological agents through the gaps.

11. The method of claim 10, further comprising the step of determining a selected gap size by a software algorithm, wherein the container openings and the sleeve openings are aligned to form gaps of the selected gap size by means of a computer processor.

12. A system for dispersing biological agents, comprising:
an unmanned vehicle;
an apparatus mounted to the unmanned vehicle, the apparatus comprising a rotatable cylindrical container having a central axis and an inner cavity surrounded by a container wall with a plurality of container openings arranged circumferentially around the central axis; and
a plurality of biological agents contained within the inner cavity of the cylindrical container, wherein the openings in the container wall are configured to allow passage of the biological agents out of the cylindrical container.

13. The system of claim 12, wherein the biological agents are predatory mites.

14. The system of claim 13, wherein the predatory mites are selected from a group consisting of: Amblyseius swirskii, Phytoseiulus persimilis, Amblyseius califomicus, Amblyseius cucumeris, Amblyseius degenerans, Hypoaspis miles, Aphidoletes aphidimyza, Aphelinus abdominalis, Aphidius colemani, Chrysoperla camea, Aphidius ervi, and Diglyphus isaea.

15. The system of claim 12, wherein the unmanned vehicle is an aerial drone.

16. The system of claim 12, further comprising a motor coupled to the apparatus and configured to rotate the cylindrical container around the central axis.

17. The system of claim 12, further comprising a sleeve wrapped at least partially around the container wall, the sleeve having a plurality of sleeve openings capable of alignment, partial alignment, or non-alignment with the container openings.

18. The system of claim 17, wherein the position of the sleeve relative to the container wall is adjustable and determines alignment, partial alignment or non-alignment of the sleeve openings with the container openings.

19. The system of claim 18, further comprising a sleeve-adjustment mechanism coupled to the sleeve and configured to adjust the position of the sleeve relative to the container wall.

20. The system of claim 19, further comprising a computer processor having instructions to control the sleeve-adjustment mechanism based on at least one of user input or a software algorithm.
